(19) United States
(12) Patent Application Publication
(10) Pub. No.: US 2009/0196464 A1
(43) Pub. Date: Aug. 6, 2009

(54) Continuous face recognition with online learning

(75) Inventors: Nevenka Dimitrova, Pelham Manor, NY (US); Jun Fan, Belmont, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/587,799

(22) PCT Filed: Jan. 31, 2005
(86) PCT No.: PCT/IB2005/050399

§ 371 Date: Jan. 26, 2009

Related U.S. Application Data
(60) Provisional application No. 60/541,206, filed on Feb. 2, 2004.
(60) Provisional application No. 60/637,370, filed on Dec. 17, 2004.

(51) Int. Cl. G06K 9/00

(52) U.S. Cl. 382/118

(57) ABSTRACT

System and method of face classification. A system (10) comprises a face classifier (40) that provides a determination of whether or not a face image detected in a video input (20) corresponds to a known face in the classifier (40). The system (10) adds an unknown detected face to the classifier (40) when the unknown detected face meets one or more persistence criteria (100) or prominence criteria.

This application claims priority to U.S. provisional patent application 60/541,206, entitled “Continuous Face Recognition With Online Learning” of Nevenka Dimitrova and Jun Fan, filed Feb. 2, 2004.

The contents of the above-identified U.S. provisional patent application 60/541,206, entitled “Continuous Face Recognition With Online Learning” of Nevenka Dimitrova and Jun Fan, filed Feb. 2, 2004, are hereby incorporated by reference herein.

The invention generally relates to face recognition. More particularly, the invention relates to improvements in face recognition, including online learning of new faces.

Face recognition has been an active area of research, with many techniques currently available. One such technique uses a probabilistic neural network (generally “PNN”) to determine whether it recognizes an input vector representing a face detected in a video stream or other image. The PNN determines whether a face is “known” or “unknown” by comparison of the input vector with a fixed number of known faces with which the PNN has been trained. If a comparison results in a sufficiently high confidence value, for example, the face is deemed to be that of the corresponding face in the database. If the comparison does not, the input face is simply deemed to be “unknown” and discarded. PNNs are generally described, for example, in “Probabilistic Neural Network for Pattern Classification”, by P. K. Patra et al., Proceedings of the 2002 International Joint Conference on Neural Networks (IEEE IJCNN '02), May 2002, Vol. II, pp. 1200-1205, the contents of which are hereby incorporated by reference herein.

One difficulty in prior techniques applying PNN to face recognition is that input faces are only compared to faces in the pre-trained database. In other words, a face can only be determined to be “known” if it is found to correspond to one of the faces used to train the PNN. Thus, the same input face may be repeatedly determined to be “unknown” if it is not in the database, even though the same face has previously been detected by the system.

U.S. Patent Application Publication 2002/0136433 A1(“'433 publication”) describes a face recognition system that applies online training for unknown faces in an “adaptive eigenface” system. According to the '433 publication, an unknown face that is detected is added to the class of known faces. The '433 publication also refers to tracking the face so that multiple images of the unknown face may be added to the database. However, the '433 publication does not teach selectivity in determining whether or not to add unknown faces to the database. Thus, the '433 database may rapidly expand with new faces and also slow down the performance of the system. While capture of all unknown images may be desirable for certain applications (such as surveillance, where it may be desirable to capture every face for later recognition), it may be undesirable in others. For example, in a video system where rapid identification of prominent faces is important, indiscriminate expansion of the database may be undesirable.

The present invention includes, among other things, addition of new faces to a database or the like used in face recognition and keeps learning new faces. When a new face is added to the database, it may be detected as a “known” face when it is found again in the input video subsequently received. One aspect discriminates which new faces are added to the database by applying rules to ensure that only new faces that persist in the video are added to the database. This eliminates “spurious” or “fleeting” faces from being added to the database.

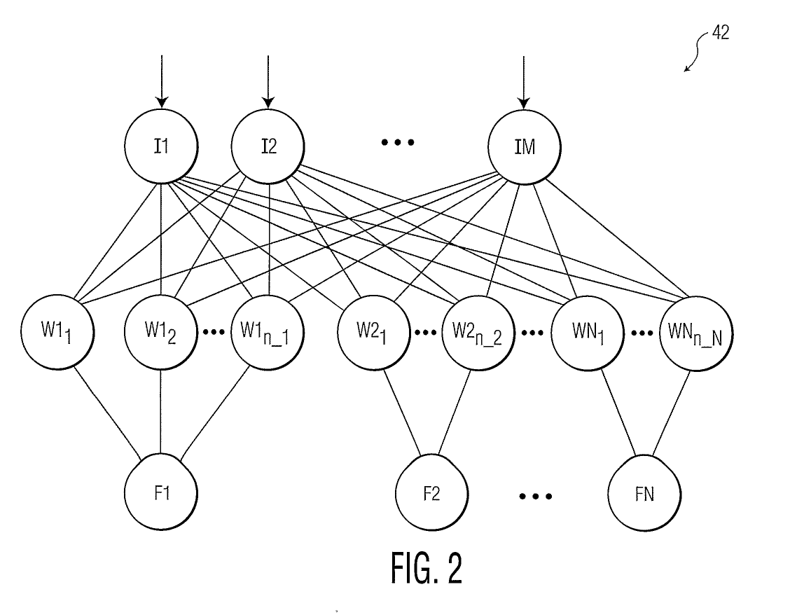

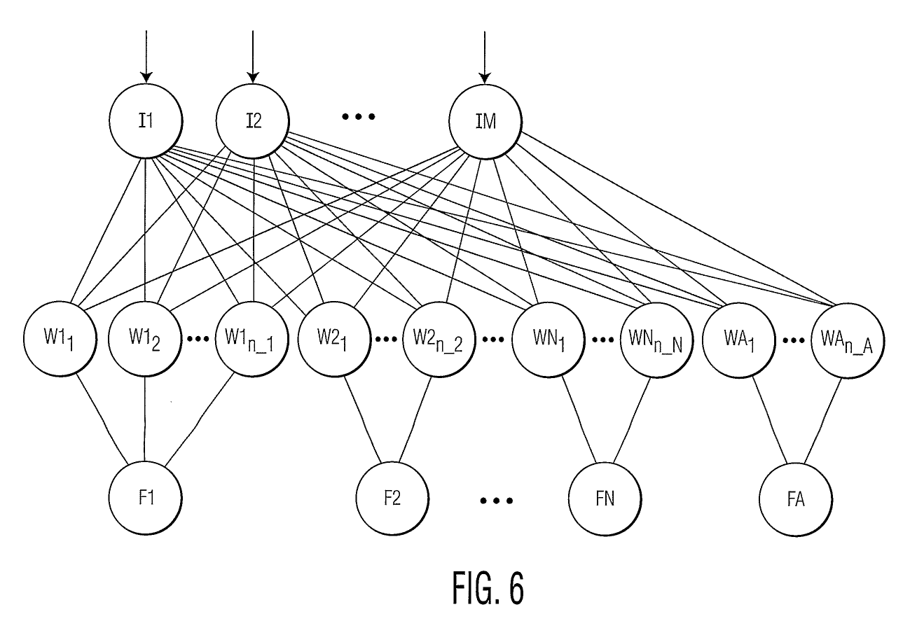

A side note is made here regarding terminology as utilized in the description below: In general, a face is considered “known” by a system if data regarding the facial features is stored in the system. In general, where a face is “known”, an input containing the face may be recognized by the system as corresponding to the stored face. For example, in a PNN based system, a face is “known” if there is a category corresponding to the face and is considered “unknown” if there is no such category. (Of course, the existence of a category corresponding to a face does not necessarily mean that the processing will always determine a match or hit, since there may be “misses” between an input known face and its category.) A “known” face will generally be given an identifier by the system, such as a generic label or reference number. (As will be seen labels F1, F2, . . . , FN in FIGS. 2 and 6 and FA in FIG. 6 represent such generic identifiers in the system.) A system may have stored data regarding facial features and such system identifiers or labels for the faces without necessarily having the identity of the person (such as the person's name). Thus, a system may “know” a face in the sense that it includes stored facial data for the face without necessarily having data relating to the personal identification of the face. Of course, a system may both “know” a face and also have corresponding personal identification data for the face.

Thus, the invention comprises a system having a face classifier that provides a determination of whether or not a face image detected in a video input corresponds to a known face in the classifier. The system adds an unknown detected face to the classifier when the unknown detected face persists in the video input in accordance with one or more persistence criteria. The unknown face thus becomes known to the system.

The face classifier may be, for example, a probabilistic neural network (PNN), and the face image detected in the video input is a known face if it corresponds to a category in the PNN. When the persistence criteria is met for an unknown face, the system may add the unknown face to the PNN by addition of a category and one or more pattern nodes for the unknown face to the PNN, thereby rendering the unknown face to be known to the system. The one or more persistence criteria may comprise detection of the same unknown face in the video input for a minimum period of time.

The invention also comprises a like method of face classification. For example, a method of face recognition comprising the steps of: determining whether or not a face image detected in a video input corresponds to a known face in storage, and adding an unknown detected face in storage when the unknown detected face persists in the video input in accordance with one or more persistence criteria.

The invention also comprises like techniques of face classification using discrete images, such as photos. It also provides for adding an unknown face (in either the video or discrete image case) when a face in at least one image meets one or more prominence criteria, e.g., a threshold size.

The preferred exemplary embodiment of the present invention will hereinafter be described in conjunction with the appended drawings, where like designations denote like elements, and:

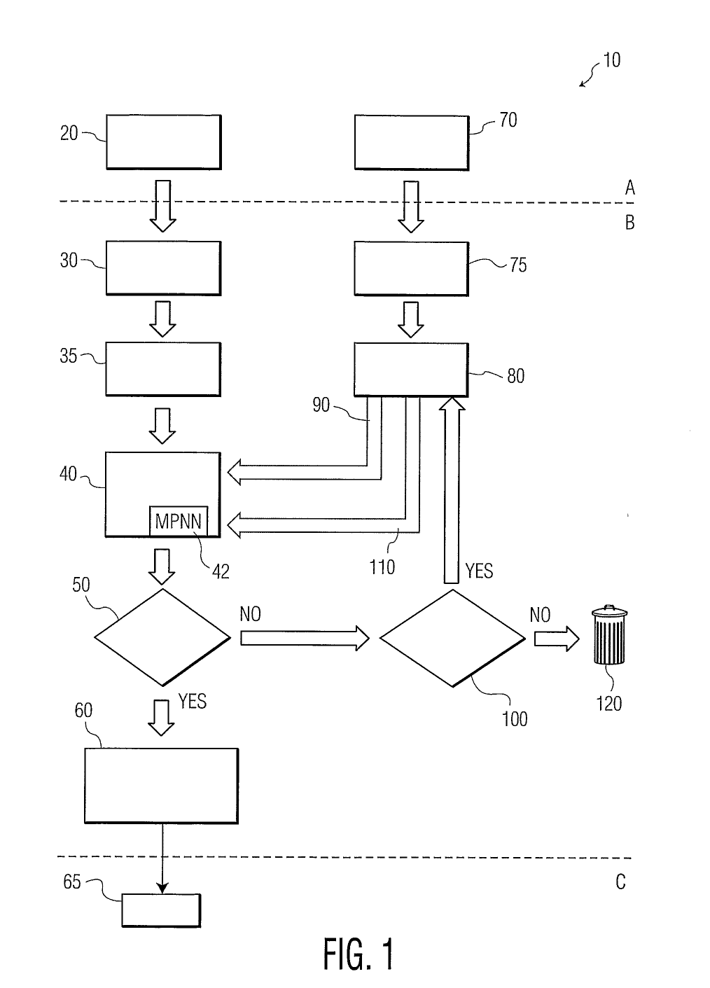

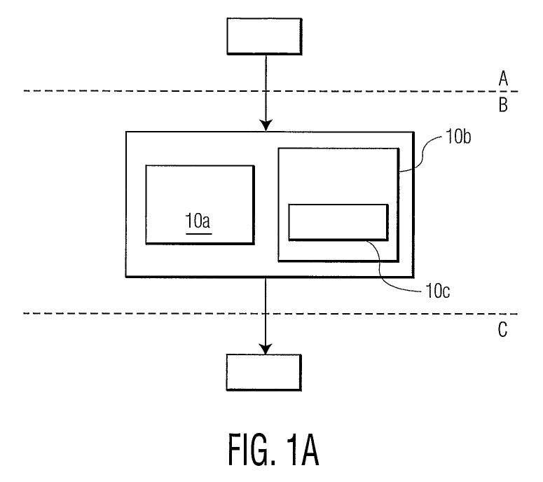

FIG. 1 is a representative block diagram of a system according to an embodiment of the invention;

FIG. 1a is a representative diagram of a different level of the system of FIG. 1;

FIG. 2 is an initially trained modified PNN of a component of the system of FIG. 1;

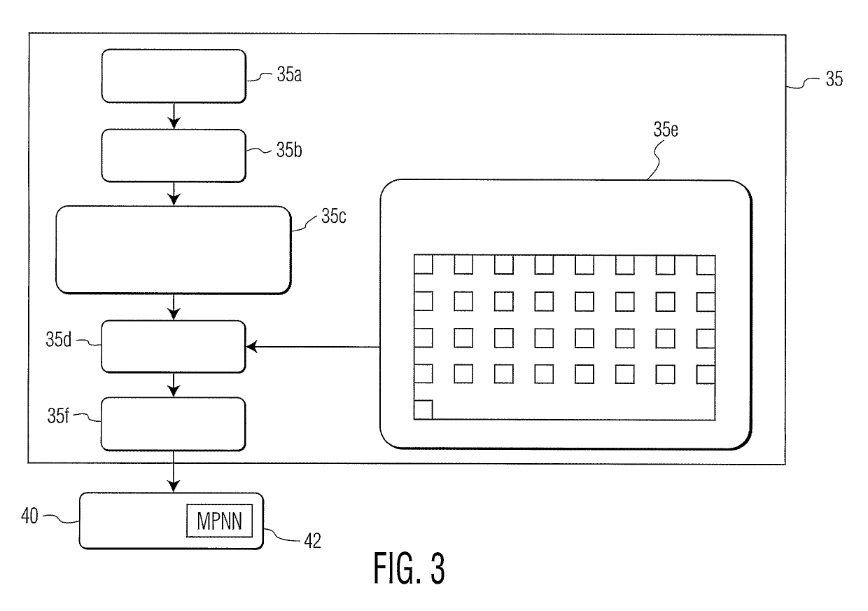

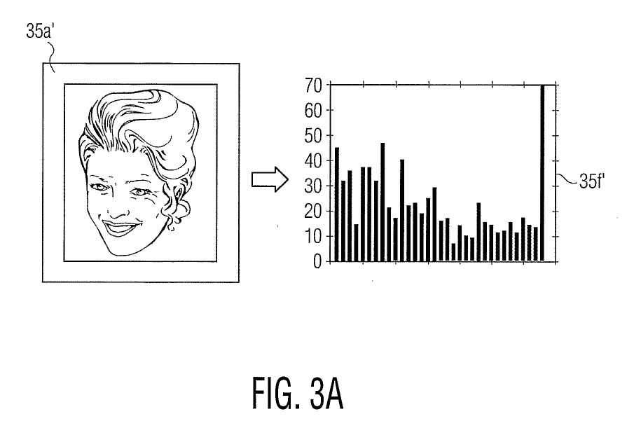

FIG. 3 is a more detailed representation of a number of components of the system of FIG. 1;

FIG. 3a is a vector quantization histogram created for a face image in accordance with a feature extraction component as in FIG. 3;

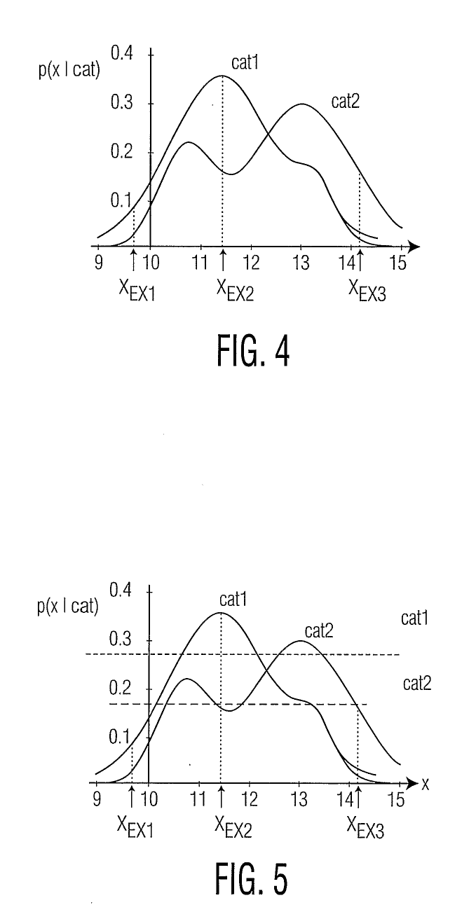

FIG. 4 is a representative one-dimensional example used in showing certain results based on a probability distribution function;

FIG. 5 shows a modification of the example of FIG. 4; and

FIG. 6 is the modified PNN of FIG. 2 including a new category created by online training.

As noted above, the present invention comprises, among other things, face recognition that provides for online training of new (i.e., unknown) faces that persist in a video image. The persistence of a new face in a video image is measured by one or more factors that provide, for example, confirmation that the face is a new face and also provides a threshold that the face is one sufficiently significant to warrant addition to the database for future determinations (i.e., become a “known” face).

FIG. 1 depicts an exemplary embodiment of the invention. FIG. 1 is representative of both a system and method embodiment of the invention. The system terminology will be used below to describe the embodiment, although it is noted that the processing steps described below also serve to describe and illustrate the corresponding method embodiment. As will be readily apparent from the description below, video inputs 20 and the sample face images 70 above the top dotted line (portion A) are inputs to the system 10, which may be stored in a memory of system 10 after receipt. Processing blocks inside the dotted lines (portion “B”) comprise processing algorithms that are executed by system 10 as described further below.

As will be readily appreciated by those of skill in the art, the processing algorithms of system 10 in portion B may reside in software that is executed by one or more processors and which may be modified by the system over time (e.g., to reflect the online training of the MPNN described below). As will also become clear from the description below, the inputs to various processing block algorithms are provided by the output of other processing blocks, either directly or through an associated memory. (FIG. 1a provides a simple representative embodiment of the hardware and software components that support the processing of system 10 represented in FIG. 1. Thus, the processing of system 10 represented by the blocks in portion B of FIG. 1 may be performed by the processor 10a in conjunction with associated memory 10b and software 10c in FIG. 1a.)

The system 10 of FIG. 1 utilizes a PNN in face classifier 40, which in the embodiment described below is modified to form a modified PNN or “MPNN” 42 and will thus be referred to as “MPNN” throughout. However, it is understood that a basic (i.e., unmodified) PNN may also be used in the invention. Face classifier 40 is principally comprised of MPNN 42 in the embodiment, but may also include additional processing. For example, as indicated below, some or all of decision block 50 may be considered as part of classifier 40 separate from MPNN 42. (Also, alternative face classification techniques may be used.) Thus, face classifier 40 and MPNN 42 are shown separate for conceptual clarity, although in the embodiment of FIG. 1 as described herein they are substantially coextensive. Also, system 10 extracts facial features from sample face images and video inputs in the determination of whether the face is known or unknown. Many different facial feature extraction techniques may be utilized in the system 10, such as vector quantization (VQ) histograms or eigenface features. In the exemplary system 10 of FIG. 1, vector quantization (VQ) histogram features are used as face features.

Initially in the system 10 of FIG. 1, sample face images 70 are input to system 10 to provide an initial offline training 90 of the MPNN 42. The sample face images are for a number of different faces, namely first face F1, second face F2, . . . Nth face FN, where N is the total number of different faces included in the sample images. Faces F1-FN will comprise the initial “known” faces (or face categories) and will be “known” to the system by their category labels F1, F2, . . . , FN. The sample face images 70 used in the training typically comprise multiple sample images for face category F1, multiple sample images for F2, . . . , multiple sample images for FN. For the sample images input at block 70, it is known which images correspond to which face category.

The sample images for each face category are used to create pattern nodes and a category for that face category in the MPNN 42 of face classifier 40. Thus, samples images corresponding to F1 are used to create pattern and category nodes for F1, sample images corresponding to F2 are used to create pattern and category nodes for F2, etc. Sample face images 70 are processed by feature extractor 75 to create a corresponding input feature vector X for each sample face image. (In the description of the offline training 90 below, “X” generically refers to the input feature vector for the particular sample image under consideration.) In the exemplary embodiment, input feature vector X comprises a VQ histogram extracted from each of the sample images 70. The VQ histogram technique of feature extraction is well known in the art and also described further below in the context of analogous feature extraction in block 35 for input video images. Thus, input feature vector X for each sample image will have a number of dimensions determined by the vector codebook used (33 in the particular example below).

After input feature vector X of a sample image is extracted, it is normalized by classifier trainer 80. Classifier trainer 80 also assigns the normalized X as a weight vector W to a separate pattern node in the MPNN 42. Thus, each pattern node also corresponds to a sample image of one of the faces. Trainer 80 connects each pattern node to a node created for the corresponding face in the category layer. Once all sample input images are received and processed in like manner, the MPNN 42 is initially trained. Each face category will be connected to a number of pattern nodes, each pattern node having a weight vector corresponding to a feature vector extracted from a sample face image for the category. Collectively the weight vectors of the pattern nodes for each face (or category) create an underlying probability distribution function (PDF) for the category.

FIG. 2 is a representation of an MPNN 42 of face classifier 40 as initially offline trained 90 by the classifier trainer 80. A number n_{—}1 of the input sample images output by block 70 correspond to face F1. Weight vector W1₁ assigned to first pattern node equals a normalized input feature vector extracted from first sample image of F1; weight vector W1₂ assigned to second pattern node equals a normalized input feature vector extracted from second sample image of F1; . . . ; and weight vector W1ₙ_{_{—}}₁ assigned to n_{—}1^{th} pattern node equals a normalized input feature vector extracted from n_{—}1^{th} sample image of F1. The first n_{—}1 pattern nodes are connected to the corresponding category node F1. Similarly, a number n_{—}2 of the input sample images correspond to face F2. The next n_{—}2 pattern nodes having weight vectors W2₁-W2ₙ_{_{—}}₂, respectively, are created in like manner using the n_{—}2 sample images of F2. The pattern nodes for face F2 are connected to category F2. Subsequent pattern nodes and category nodes are created for subsequent face categories in like manner. In FIG. 2, the training uses multiple sample images for N different faces.

An algorithm for creating the initially trained MPNN of FIG. 2 is now briefly described. As noted above, for a current sample face image input at block 70, feature extractor 75 first creates a corresponding input feature vector X (which in the particular embodiment is a VQ histogram, described below). Classifier trainer 80 converts this input feature vector to a weight vector for a pattern node by first normalizing the input feature vector by dividing the vector by its respective magnitude:

X′=X•(1/\sqrt{ΣX²}) (1)

The current sample image (and thus currently corresponding normalized feature vector X′) corresponds to a known face Fj, where Fj is one of the faces F1, F2, . . . , FN of the training. Also, as noted, there will generally be a number of sample images for each known face in the stream of sample faces of block 70. Thus, current sample image will generally be the m-th sample image corresponding to Fj output by block 70. The normalized input feature vector X′ is thus assigned as a weight vector to the m-th pattern node for category Fj:

Wjₘ=X′ (2)

The pattern node with weight vector Wjₘ is connected to the respective category node Fj. The other sample face images input by block 70 are converted to input feature vectors in feature extraction block 75 and processed in like manner by classifier trainer 80 to create the initially configured MPNN 42 of face classifier shown in FIG. 2.

For example, referring back to FIG. 2, if the current sample image input by block 70 is a first sample image for face F1, then feature extractor 75 creates input feature vector X for the image. Classifier trainer 80 normalizes input feature vector and assigns it as the weight vector W1₁ for the first pattern node for F1. The next sample image may be for third sample image for face F9. After extraction of an input feature vector X for this next sample image at block 75, classifier trainer 80 normalizes the feature vector and then assigns the normalized feature vector as weight vector W9₃ for the third pattern node for F9 (not shown). Some input images later, another sample image in the training may again be for F1. This image is processed in like manner and assigned as weight vector W1₂ for the second pattern node for F1.

All sample face images 70 are processed in like manner, resulting in the initially trained MPNN 42 of classifier 40 of FIG. 2. After such initial offline training 90, face classifier 40 comprises an MPNN 42 having pattern layer and category layer resulting from offline training and reflecting the faces used in the offline training. Such faces comprise the initially “known” faces of the offline trained MPNN-based system.

As described further below, input nodes I1, I2, . . . , IM will receive a feature vector of a detected face image and determine if it corresponds to a known face category. Thus, each input node is connected to each pattern node and the number of input nodes equals the number of dimensions in the feature vectors (33 in the particular example below).

The training of MPNN may be done as a sequence of input sample images, as described above, or multiple images may be processed simultaneously. Also, it is clear from the above description that the order of input of the sample face images is irrelevant. Since the face category is known for each sample image, all samples for each known face may be submitted in sequence, or they may be processed out of order (as in the example given above). In either case, the final trained MPNN 42 will be as shown in FIG. 2.

It is noted that the MPNN as configured immediately after such initial offline training of system 10 is analogous to those in prior art PNN systems that only use offline training. For example, such offline training 90 may be done in accordance with the above-cited document by Patra et al.

It is noted here (and further described below) that the present invention does not necessarily require offline training 90. Instead the MPNN 42 may be built up using solely online training 110, also further described below. However, for the currently described embodiment, the MPNN 42 is first trained using offline 90 training and is as shown in FIG. 2. After the initial offline training 90 of MPNN 42 as described above, the system 10 is used to detect a face in a video input 20 and, if detected, to determine whether the detected face corresponds to a known face of one of the categories of the MPNN 42. Referring back to FIG. 1, video input 20 is first subject to an existing technique of face detection 30 processing, which detects the presence and location of a face (or faces) in the video input 20. (Thus, face detection processing 30 merely recognizes that an image of a face is present in the video input, not whether it is known.) System 10 may use any existing technique of face detection.

Face detection algorithm 30 may thus utilize the known application of AdaBoost to rapid object detection as described in “Rapid Object Detection Using A Boosted Cascade of Simple Features” by P. Viola and M. Jones, Proceedings of the 2001 IEEE Conference on Computer Vision and Pattern Recognition (IEEE CVPR '01), Vol. I, pp. 511-518, December 2001, the contents of which are hereby incorporated by reference herein. The basic face detection algorithm 30 used may be as described in Viola, namely, it is structured in cascaded stages, with each stage being a strong classifier and each stage comprised of several weak classifiers, each weak classifier corresponding to a feature of the image. Input video images 20 are scanned from left to right, top to bottom, and rectangles of different sizes in the image are analyzed to determine whether or not it contains a face. Thus, stages of the classifier are applied in succession to a rectangle. Each stage yields a score for the rectangle, which is the sum of the responses of the weak classifiers comprising the stage. (As noted below, scoring for the rectangle typically involves looking into two or more sub-rectangles.) If the sum exceeds a threshold for the stage, the rectangle proceeds to the next stage. If the rectangle's scores pass the thresholds for all stages, it is determined to include a face portion, and the face image is passed to feature extraction 35. If the rectangle is below the threshold for any stage, the rectangle is discarded and the algorithm proceeds to another rectangle in the image.

The classifier may be constructed as in Viola by adding one weak classifier at a time that are evaluated using a validation set to build up the stages or strong classifiers. The newest weak classifier is added to the current stage under construction. Each round t of boosting adds a rectangular feature classifier h to the current set of features in the strong classifier under construction by minimizing:

$${E}_{t} = {\sum }_{i}^{ } {D}_{t} ( i ) exp ( - {α}_{t} {y}_{i} {h}_{t} ( {x}_{i} ) ) \qquad ( 3 )$$

The above equation 3 is equivalent to the one used in Viola's procedure, and Eₜ represents a weighted error associated with the t^{th} rectangular feature classifier hₜ being evaluated using rectangular training example xᵢ. (The lower case notation “xᵢ” used for the rectangular example distinguishes it from the feature vector notation X of images used in the MPNN.) Fundamentally hₜ(xᵢ) is a weighted sum of sums of pixels in particular rectangular sub-regions of training example xᵢ. If hₜ(xᵢ) exceeds a set threshold, then the output of hₜ(xᵢ) for example xᵢ is 1 and, if not, the output of hₜ(xᵢ) is −1. Because h is restricted in the above equation to +1 or −1, the variable at is the influence (magnitude) of this weak hypothesis h on the strong classifier under construction. Also, yᵢ≡[−1, 1] is the target label of example xᵢ (that is, whether xᵢ is a negative or positive example of feature h, which is objectively known for the examples of the training set). D is a weighting factor for the ith example for the hₜ feature.

Once the minimum E is determined in this manner, the corresponding rectangular feature classifier h (as well as its magnitude α) is used to construct the new weak classifier. A custom decision threshold for h is also determined using the training set and based on the distribution of positive and negative examples. The threshold is selected that best partitions the positive and negative examples based on design parameters. (The threshold is referred to in the above-referenced Viola document as θⱼ.) As noted, the weak classifier is also comprised of α, which is a real-valued number that denotes how much influence the rectangular feature classifier h selected has on the strong classifier under construction (and is determined from the error E determined in the training) When implemented, an input rectangular portion of an image is also typically analyzed by h based on the weighted sum of pixels in two or more sub-rectangles of the input rectangle, and the output of h is set to 1 if the threshold (as determined from the training) is exceeded for the input rectangle and h=−1 if it does not. The output of new weak classifier is the binary output of h times the influence value α. The strong classifier is comprised of the sum of the weak classifiers added during the training.

Once a new weak classifier is added, if the classifier's performance (in terms of detection rates and false alarm rates) meets the desired design parameters for the validation set, then the newly added weak classifier completes the stage under construction, since it adequately detects its respective feature. If not, another weak classifier is added and evaluated. Once stages are constructed for all desired features and perform in accordance with the design parameters for the validation set, the classifier is completed.

A modification of the above-described structure of the Viola weak classifiers may alternatively be utilized for face detector 30. In the modification, α is folded into h during the selection of h for the new weak classifier. The new weak classifier h (which now incorporates α) is selected by minimizing E in manner analogous to that described above. As to the implementation of the weak classifier, “boosting stumps” are utilized in the modification. Boosting stumps are decision trees that output the left or right leaf value based on the decision made at the non-leaf parent mode. Thus, weak classifier is comprised of a decision tree that outputs one of two real values (one of two leafs c_left and c_right) instead of 1 and −1. Weak classifier is also comprised of a custom decision threshold, described below. For an input rectangle portion of an image, the selected rectangular feature classifier h is used to determine if the weighted sum of the sums of pixel intensities between sub-rectangular regions of the input rectangle is greater than the threshold. If greater, c_left is output from the weak classifier, if less, c_right is output.

Leaves c_left and c_right are determined during the training of the selected h, based on how many positive and negative examples are assigned to the left and right partitions for a given threshold. (Examples are objectively known to be positive or negative because ground truth on the training set is known.) The weighted sum of sums from the rectangles are evaluated over the entire sample set, thus giving a distribution of difference values, which is then sorted. From the sorted distribution and in view of the required detection and false alarm rates, the goal is to select a partition wherein most positive examples fall to one side and most negative examples fall to the other. For the sorted distribution, the optimum split (giving the custom decision threshold used for the weak classifier) is done by choosing a partition that minimizes T in the following equation:

$$T = 2 ( \sqrt{{W}_{+}^{Left} {W}_{-}^{Left}} + \sqrt{{W}_{+ }^{Right} {W}_{-}^{Right} } ) \qquad ( 4 )$$

where W denotes the weight of the examples in the training set that fall to the left or right of the partition under consideration that are either “positive” or “negative”.

The selected partition (that minimizes T) creates the custom decision threshold; also, c_left and c_right are computed from the training data distribution according to the equations:

$$c\_left = \frac{1}{2} ln ( \frac{{W}_{+}^{Left} + ɛ}{{W}_{-}^{Left} + ɛ} ) and \\ c\_right = \frac{1}{2} ln ( \frac{{W}_{+}^{Right} + ɛ}{{W}_{-}^{Right} + ɛ} ) \qquad ( 5 , 6 )$$

where W now denotes the weight of the examples that are assigned to the left or right of the selected partition that are either “positive” or “negative” (and ε is a smoothing term to avoid numerical problems caused by large predictions). These values serve to keep the weights of the next iteration of weak classifier balanced, that is, keep the relative weights of positive and negative examples on each side of the boundary substantially equal.

As noted, although weak classifiers may be structured as in Viola, alternatively they may be structured as decisions stumps described directly above. In addition, it is noted that the training of either weak classifier may use alternative techniques. According to one technique, to test the weak classifier currently being added, the examples of the validation set are scanned through all previously added weak classifiers of prior stages and weak classifiers previously added to the current stage. However, once a prior weak classifier is adopted and scored, the score does not change. Thus, in a more efficient alternative technique, the rectangles that pass through all prior stages and their scores for the prior stages are stored. Rather than running the examples through all prior stages, the prior scores for these remaining rectangles are used in the training of the current weak classifier, and the remaining rectangles only have to be run through the current weak classifier in order to update the scores.

Once a face image is detected in the video 20 by face detection 30, it is processed in feature extractor 35 to create a VQ histogram for the image. This feature extraction processing results in a feature vector X_{D} for the detected image. The notation X_{D} (for X “detected”) is used to emphasize the vector corresponds to detected face image (35a below) in video stream 20, not a sample face image in the training. However, it is noted that feature vector X_{D} for the detected image is extracted in the same manner as the input feature vectors X discussed above for the sample face images used in the offline training 90. Thus, feature extractors 35, 75 may be the same in system 10. The video frames containing the detected face images and the sample images used in training may be in the same raw input format, in which case the feature extraction processing is identical.

Feature extraction by feature extractor 35 is now described in more detail with respect to the face image from video input 20 detected in face detector 30. FIG. 3 shows the elements of feature extractor 35 used to transform the detected face image into a VQ histogram for input to the face classifier 40. The face image detected in the video input (designated face segment 35a in FIG. 3) is forwarded to low-pass filter 35b. Face segment 35a at this point resides in a video frame still in its raw video format. Low-pass filter 35a is used to reduce high-frequency noise and extract the most effective low frequency component of face segment 35a for recognition. Face segment is then divided into 4-by-4 blocks of pixels (processing block 35c). In addition, the minimum intensity is determined for each 4-by-4 pixel block and subtracted from its respective block. The result is a variation in intensity for each 4-by-4 block.

In processing block 35d, each such 4-by-4 block of the face image is compared with the codes in a vector codebook 35e stored in memory. Codebook 35e is well-known in the art and systematically organized with 33 codevectors having monotonic intensity variation. The first 32 codevectors are generated by changing direction and range of intensity variation, and the 33rd vector contains no variation and direction, as seen in FIG. 3. The codevector selected for each 4-by-4 block is the codevector having the most similar match to the variation in intensity determined for the block. Euclidean distance is used for distance matching between the image blocks and codevectors in the codebook.

Each of the 33 codevectors thus has a specific number of matching 4-by-4 blocks in the image. The number of matches for each codevector is used to generate VQ histogram 35f for the image. VQ histogram 35f is generated having codevector bins 1-33 along the x axis and showing the number of matches for each codevector in the y dimension. FIG. 3a represents a VQ histogram 35f that is generated for a face segment 35a′ by the processing of a feature extractor such as that shown in FIG. 3. Bins for codevectors 1-33 are shown along the x axis, and the number of matches between each codevector and 4-by-4 image blocks in the image 35a′ are shown along the y axis. As noted, in this exemplary embodiment VQ histogram is used as the image feature vector X_{D} for the detected face image. (Equivalently, the image feature vector X_{D} as used in the processing may be represented as 33 dimensional vector X_{D}=(no. matches for codevector 1, no. matches for codevector 2, . . . , no matches for codevector V), where V is the last codevector number in the codebook (for the above-described codebook, V=33).

The document “Face Recognition Using Vector Quantization Histogram Method” by K. Kotani et al., Proceedings of the 2002 International Conference on Image Processing (IEEE ICIP '02), Vol. II, pp. 105-108 (September 2002) is hereby incorporated herein by reference, and describes representation of facial features using a VQ histogram that is substantially as described above with respect to generation of VQ histogram 35f from input facial image 35a by feature extractor 35.

FIG. 3 also shows MPNN 42 of face classifier 40. VQ histogram 35f outputs the feature vector X_{D} for the input face image 35a. Feature vector X_{D} is forwarded to the input layer of MPNN 42, and processed to determine whether the underlying face segment is known or unknown.

Returning now to the initial trained configuration of MPNN 42 as shown in FIG. 2, as described above, each pattern node has an assigned weight vector W equal to a normalized input feature vector X of a sample training image in the face category. Because input feature vectors in the training are extracted from the sample images in the same manner as for X_{D}, both vectors have the same number of dimensions (33 in the exemplary embodiment of 33 codevectors used in extraction) and represent the same feature of their respective image in corresponding vector dimensions. Thus, X_{D} of the detected image and the weight vectors W for the sample images of a category are compared to determine the correspondence between X_{D} and the known face of the category.

X_{D} is input to MPNN 42 via the input layer nodes and MPNN 42 evaluates its correspondence with each face category using the weight vectors in the pattern nodes. MPNN 42 compares X_{D} and a known face category (F1, F2, . . . ) by determining a separate PDF value for each category. First, the input layer normalizes the input vector X_{D}, (by dividing it by its magnitude) so that it is scaled to correspond with prior normalization of the weight vectors of the pattern layer during offline training:

X′_{D}=X_{D}•(1/\sqrt{ΣX_{D}²}) (7)

Second, in the pattern layer, MPNN 42 performs a dot product between the normalized input vector X′_{D} and the weight vector W of each pattern node shown in FIG. 2, thus resulting in an output vector value Z for each pattern node:

$$\begin{matrix}Z {1}_{1} = {X}_{D}^{′} \cdot W {1}_{1} , & ( 8 a ) \\ Z {1}_{2} = {X}_{D}^{′} \cdot W {1}_{2} , \\ ⋮ & ( 8 b ) \\ {ZN}_{n\_N} = {X}_{D}^{′} \cdot {WN}_{n\_N} & ( 8 n )\end{matrix}$$

where the reference notations for the weight vectors W for the pattern nodes (and thus the resulting output vectors Z) are as shown in FIG. 2 and as described above with respect to the offline training.

Finally, the output values of pattern nodes corresponding to each category are aggregated and normalized to determine a value of the PDF (function f) for input vector X_{D} for each respective category. Thus, for the j-th category Fj, output values Zj₁-Zjₙ_{_{—}}ⱼ for pattern nodes of the j-th category are used, where n_j is the number of pattern nodes for category j. The PDF value f is calculated for a category Fj under consideration as follows:

$${f}_{Fj} ( {X}_{D} ) = {\sum }_{l = 1}^{n\_j} ( exp [ ( {Zj}_{l} - 1 ) / {σ}^{2} ] ) / n\_j \qquad ( 9 )$$

where σ is the smooth factor. Using equation 9 for j=1 to N, PDF values f_{F1}(X_{D}), . . . f_{FN}(X_{D}) are calculated for categories F1, . . . ,FN, respectively, using the output values Z of the pattern nodes corresponding to each respective category. Because the PDF value f for each category is based on a sum of the output values Z of the category, it follows that the greater the value f for a category, the greater the correspondence between X_{D} and the weight vectors for that category.

The MPNN 42 then selects the category (designated the ith category or Fi) that has the largest value f for input vector X_{D}. Selection of the ith category by the MPNN 42 uses one of the implementations of the Bayes Strategy, which seeks the minimum risk cost based on the PDF. Formally, the Bayes decision rule is written as:

d(X_{D})=Fi if f_{Fi}(X_{D})>f_{Fj}(X_{D})∀i≠j (10)

Category Fi having the largest PDF (as measured by f) for input vector X_{D} provides a determination that input vector X_{D} (corresponding to face segment 42a) potentially matches known face category Fi. Before actually deeming there is a match, the MPNN 42 generates a confidence measurement, which compares the PDF of vector X_{D} for the potential matching category i with the sum of the PDFs of vector X_{D} for all categories:

$$Ci = {f}_{Fi} ( {X}_{D} ) / ( {\sum }_{j = 1}^{N} {f}_{Fj} ( {X}_{D} ) ) \qquad ( 11 )$$

If the confidence measurement surpasses a confidence threshold (e.g., 80%), then a match between input vector X_{D} and category i is found by the system. Otherwise it is not.

However, the confidence measurement based on the decision function result as described directly above can result in undesirably high confidence measurements in cases where the largest PDF value f for an input vector is nonetheless too low for a match with the category to be declared. This is due to the confidence measurements as calculated above being generated by comparing the relative results from the PDF output of the categories for a given input vector. A simple generic example in one-dimension illustrates this:

FIG. 4 represents the PDF of two categories (Cat1, Cat2). The PDF function for each category is generically represented in FIG. 4 as “p(X|Cat)” (or the probability that input feature vector X belongs to category Cat) versus the one dimensional feature vector X. Three separate one dimensional input feature vectors X_{Ex1}, X_{Ex2}, X_{Ex3} are shown which are used to illustrate how undesirably high confidence values may result. For input vector X_{Ex1}, the largest PDF value corresponds to category Cat1 (i.e., p(X_{Ex1}|Cat1)≈0.1 and p(X_{Ex1}|Cat2)≈0.02). By applying a Bayes rule analogous to that given in equation 10, Cat1 is thus selected. Also, a confidence measurement may be calculated for Cat1 for X_{Ex1} analogous to that given in equation 11:

$$\begin{matrix}\begin{matrix}Confi\_Ex1 = p ( {X}_{Ex 1} \vert Cat 1 ) / [ p ( {X}_{Ex 1} \vert Cat 1 ) + p ( {X}_{Ex 1} \vert Cat 2 ) ] \\ \approx 0.1 / [ 0.1 + 0.02 ] \\ = 83 \%\end{matrix} & ( 12 )\end{matrix}$$

However, since the PDF values for input feature vector X_{Ex1} are very low (0.1 for Cat1 and lower for Cat2), this implies that the correspondence between the input vector and the weight vectors in the pattern nodes is small, and that X_{Ex1} should therefore be identified as an “unknown” category.

Other like undesirable results are also evident from FIG. 4: Referring to input feature vector X_{Ex2}, it is clearly appropriate to match it with category Cat1 since it corresponds to the maximum value of Cat1. Also, calculation of the confidence value Confi_Ex2 in manner analogous to equation 12 results in a confidence measurement of approximately 66%. However, Confi_Ex2 should not be lower than Confi_Ex1, since X_{Ex2} is much closer than X_{Ex1} is to the maximum value of the PDF for Cat1. Another undesirable result is shown for X_{Ex3}, where Cat2 is selected with a confidence value of approximately 80%, even though X_{Ex3} is likewise far to one side of the maximum value of the PDF for Cat2.

FIG. 5 exemplifies a technique for avoiding such undesirable outcomes when treating low PDF values for a given input feature vector. In FIG. 5, a threshold is applied to each of the categories Cat1, Cat2 of FIG. 4. In addition to choosing the category having the largest PDF value, an input feature vector X must meet or exceed the threshold for the category before it is deemed a match. The threshold may be different for each category. For example, the threshold may be a certain percentage of the maximum value of the PDF for the category (e.g., 70%).

As seen in FIG. 5, Cat1 is again the category having the largest PDF value for feature vector X_{Ex1}. However, p(X_{Ex1}|Cat1)≈0.1, and does not surpass the threshold for Cat1, which is approximately 0.28. Thus, feature vector X_{Ex1} is determined to be “unknown”. Likewise, since the PDF value of X_{Ex3} does not surpass the threshold for Cat2, X_{Ex3} is determined to be “unknown”. However, since the PDF value for X_{Ex2} surpasses the threshold for Cat1, Cat1 is selected for X_{Ex2}, with a confidence level of 66% as calculated above.

It is clear that analogous undesirable scenarios can arise when in the case of multi-dimensional cases (such as the 33 dimensional case in the exemplary embodiment). For example, the PDF value for the largest category for an input multi-dimensional feature vector may nonetheless be too low to declare a category match. However, when the largest PDF value is used along with the PDF values of the other categories (having even lower magnitude) in a confidence measurement, an unduly high confidence value may result.

Returning to the exemplary embodiment, in order to properly treat low PDF value outputs f for a given input vector, as previously indicated a modified PNN (MPNN 42) is employed. In the MPNN 42, the category having the largest PDF value f for an input vector is provisionally selected. However, the value f(X) for the category must also meet or exceed a threshold for the provisionally selected category. The threshold may be different for each category. For example, the threshold may be a certain percentage of the maximum value of the PDF for the category (e.g., 70%). The thresholding of PDF values f generated for an input vector X_{D} utilized in the MPNN of the embodiment is applied as a modification of the Bayes decision rule given above. Thus, the Bayes decision rule used by the MPNN of the embodiment is:

d(X_{D})=Fi, if (f_{Fi}(X_{D})>f_{Fj}(X_{D})) and (f_{Fi}(X_{D})≧ti) ∀i≠j (13)

d(X_{D})=unknown, if (f_{Fi}(X_{D})>f_{Fj}(X_{D})) and (f_{Fi}(X_{D})<ti) ∀i≠j (14)

where ti is the threshold of the face category (Fi) corresponding to the largest f(X_{D}) and the threshold is based upon the PDF of the category Fi. (At least because the threshold in the above-technique is not based on the PDF of an “unknown” category, it is different from a threshold described for other applications in “Identification Of Unknown Categories With Probabilistic Neural Networks” by T. P. Washburne et al., IEEE International Conference on Neural Networks, pp. 434-437 (1993).)

If d is unknown, the face is determined to be “unknown” in block 50. If a face category (Fi) is selected under the modified Bayes decision algorithm of the MPNN, the confidence value is calculated for the select category in the manner as noted above (Equation 11). If the confidence value surpasses the confidence threshold, then the input vector is deemed to correspond to the select category (Fi) and the face is determined “known” in block 50 of FIG. 1 in the sense that it corresponds to a face category. In that case, any subsequent processing relating to detection of a known face may be initiated in block 60. Such initiation is optional and may be any one of many other tasks, such as video indexing, internet searches for the identity of the face, editing, etc. In addition, system 10 may provide an output 65 (such as a simple visual or audio alarm) alerting of a match between a face segment on video input and a category (known face) in MPNN. If the training images also included personal identification (e.g., corresponding names) for the face categories, the identification may be output. On the other hand, if the confidence value does not surpass the confidence threshold, then the input vector is again deemed unknown.

Processing the determination of whether the face is known or unknown is separately shown as processing determination 50 in FIG. 1. Block 50 may include the modified Bayes decision rule (Equations 13 and 14 ) and the subsequent confidence determination (Equation 11) as described immediately. However, although block 50 is shown separately from face classifier 40 for conceptual clarity, it is understood that the Bayes decision algorithm and confidence determination is typically part of face classifier 40. This decision processing may be considered part of the MPNN 42, although it may alternatively be considered a separate component of face classifier 40.

If the face image is determined by determination 50 to be unknown, FIG. 1 shows that the face is not simply discarded but rather the processing turns to a persistence decision block 100. As described in more detail below, the video input 20 having the unknown face is monitored using one or more criteria to determine if the same face persists or is otherwise prevalent in the video. If it does, then the feature vectors X_{D} for one or more face images of the unknown face received via input 20 are sent to the trainer 80. Trainer 80 uses the data for the face images to train the MPNN 42 in face classifier 40 to include a new category for the face. Such “online” training of the MPNN 42 ensures that a prominent new (unknown) face in the video will be added as a category in the face classifier. Thus the same face in subsequent video inputs 20 may be detected as a “known” face (i.e., corresponding to a category, although not necessarily “identified” by name, for example).

As noted, when the face is determined to be unknown in block 50, persistence processing 100 is initiated. Video input 20 is monitored to determine if one or more conditions are satisfied, indicating that the MPNN 42 will be online trained using images of the unknown face. The one or more conditions may indicate, for example, that the same unknown face is continuously present in the video for a period of time. Thus, in one embodiment of the persistence processing 100, the unknown face detected is tracked in the video input using any well-known tracking technique. If the face is tracked in the video input for a minimum number of seconds (e.g., 10 seconds), then the face is deemed to be persistent by processing block 100 (“yes” arrow).

Alternatively, persistence determination block 100 may consider data for a sequence of face image segments determined to be unknown by MPNN 42 in face classifier 40 to determine if the same unknown face is present in the video for a certain period of time. For example, the following four criteria may be applied to a sequence:

1) The MPNN 42 classifier identifies a sequence of face segments in video input 20 as unknown, in the manner described above.

2) The mean of the PDF output is low for the feature vectors X_{D} extracted for face segments of the sequence (where the “PDF output” is the value f_{Fi}(X_{D}) for the largest value i, even though it doesn't surpass threshold ti). A threshold for the mean PDF output for the feature vectors may typically be, for example, less than or equal to 40% and more than 20% of the maximum PDF output. However, because this threshold is sensitive to the state of the video data, this threshold may be empirically adjusted in order to attain a desired level of detection versus false positives. This criterion serves to confirm that it is not one of the known faces, i.e., that it is an unknown face.

3) The variance of feature vectors X_{D} for the sequence is small. This may be determined by calculating the distance between input vectors by performing the standard deviation on the sequence of input vectors. A threshold for the standard deviation between input vectors may typically be, for example, in the range of 0.2 to 0.5. However, because this threshold is also sensitive to the state of the video data, this threshold may be empirically adjusted in order to attain a desired level of detection versus false positives. This criterion serves to confirm that the input vectors in the sequence correspond to the same unknown face.

4) The above three conditions last for a sequence of faces input at block 20 over a certain period of time (e.g., 10 seconds).

The first three criteria above serve to confirm it is the same unknown face throughout the segment. The fourth criterion serves as the measure of persistence, that is, what unknown face qualifies as worthy of re-training the MPNN to include. In the case of an unknown face that lasts in the video input 20 for 10 seconds or more, for example, spurious faces that flash through the video for brief periods of time (likely corresponding to crowd faces, bit actors, etc.) are eliminated from the online training. Feature vectors X_{D} for a sample of the images of the face may be stored throughout the time interval and used in the online training, when performed.

In the case where the sequence lasts for a period of time that is continuous, the processing is straightforward. In that case, some or all of the feature vectors X_{D} for the face segments of video input 20 may be stored in a buffer memory and, if the minimum period of time is exceeded, used in online training as described further below. In other cases, for example, a face may appear for very short periods of time in non-consecutive video segments, but which aggregate to exceed the minimum period of time. (For example, where there are rapid cuts between actors engaged in a conversation.) In that case, multiple buffers in persistence block 100 may each store feature vectors for unknown face images for a particular unknown face, as determined by above conditions 1-3. Subsequent face images that are determined to be “unknown” by MPNN are stored in the appropriate buffer for that face, as determined by criteria 1-3. (If an unknown face does not correspond to those found in an existing buffer, it is stored in a new buffer.) If and when a buffer for a particular unknown face accumulates enough feature vectors for face images over time to exceed the minimum period of time, the persistence block 100 releases the feature vectors to classifier trainer 80 for online training 110 for the face in the buffer.

If the sequence of faces for an unknown face is determined not to meet the persistence criteria (or a single persistence criterion), then the processing of the sequence is terminated and any stored feature vectors and data relating to the unknown face are discarded from memory (processing 120). In the case where image segments are accumulated for different faces over time in different buffers as described above, the data in any one buffer may be discarded if, after a longer period of time (e.g., 5 minutes), the face images accumulated over time does not exceed the minimum period.

If a face in the video input determined to be unknown satisfies the persistence processing, then system 10 performs an online training 110 of the MPNN 42 to include a category for the unknown face. For convenience, the ensuing description will focus on online training for unknown face “A” that satisfies persistence block 100. As described above, in the determination of the persistence of face A, the system stores a number of feature vectors X_{D} for images of face A from the sequence of images received via video input 20. The number of feature vectors may be for all of the faces of A in the sequence used in the persistence determination, or a sample. For example, input vectors for 10 images in the sequence of face A may be utilized in the training.

For a persistent face A, system processing returns to training processing 80 and, in this case, online training 110 of MPNN 42 of face classifier 40 to include face A. The 10 feature vectors used (for example) in the online training for face A may be those having the lowest variance from all the input vectors for the images in the sequence, that is, the 10 input vectors having closest to the average in the buffer. Online training algorithm 110 of trainer 80 trains the MPNN 42 to include a new category FA for face A having pattern nodes for each of the images.

The online training of new category FA proceeds in analogous manner for the initial offline training of the MPNN 42 using sample face images 70. As noted, the feature vectors X_{D} for the images of face A are already extracted in block 35. Thus, in the same manner as the offline training, classifier trainer 80 normalizes the feature vectors of FA and assigns each one as a weight vector W of a new pattern node for category FA in the MPNN. The new pattern nodes are connected to a category node for FA.

FIG. 6 shows the MPNN of FIG. 2 with new pattern nodes for new category FA. The newly added nodes are in addition to the N categories and corresponding pattern nodes developed in the initial offline training using known faces discussed above. Thus, weight vector WA₁ assigned to first pattern node for F1 equals a normalized feature vector for a first image of FA received via video input 20; weight vector WA₂ assigned to second pattern node (not shown) for FA equals a normalized feature vector for a second sample image of FA; . . . ; and weight vector WAₙ_{_{—}}_{A} assigned to n_A^{th} pattern node for FA equals a normalized feature vector for the n_{—}1^{th} sample image of FA. By such online training, face A becomes a “known” face in MPNN. MPNN 42 is now capable of determining face A in a subsequent video input 20 is a “known” face using the detection and classification processing of FIG. 1 and described above. It is again noted that a face image A in a subsequent video input 20 may be determined to be “known” in that it corresponds to a face category FA of MPNN. However, this does not necessarily mean that the face is “identified” in the sense that the name of face A is known to the system 10.

Other faces detected in the input video 20 and classified as “unknown” by system 10 in the manner described above are likewise processed by persistence processing 100. If and when the one or more criteria applied in persistence block 100 is met by another face (e.g., face B), the trainer 80 online trains 110 the MPNN 42 in the manner described above for face A. After online training, MPNN 42 includes another category (with corresponding pattern nodes) for face B. Additional unknown faces (C, D, etc.) that persist are used to online train the MPNN in like manner. Once the MPNN is trained for a face, it is then “known” to the system. Subsequent images of that face in the video input at block 20 may be determined to correspond to the newly created category for that face in the MPNN 42.

The embodiment described above utilizes video input 20 in the system. However, one skilled in the art can readily adapt the techniques described herein to use discrete images (such as photos) from a personal image library, image archive, or the like. They may also be downloaded from one or more sites on the Internet, for example, by utilizing other search software. Substitution of discrete images for the video input 20 may require some adaptation of the above-described system that will be readily apparent to one skilled in the art. (For example, if the images provided are limited to faces, then face detection 30 may be bypassed.) For discrete images, other criteria may be applied to determine if a face should be recognized as unknown and included in the online training process. For example, one such criterion is that the new face appears at least a minimum number of times, which may be specified by the user. This provides an analogous “persistence criterion” for the images.

For images, “prominence” type criteria may be used as an alternative to persistence type criteria, for example, in block 100. For example, there may only be one image containing a particular face among a set of images, yet it may be desireable to have online training for that image. As a particular example, there may be one photo of a user taken with the President of the United States in a set of hundreds taken during a trip to Washington D.C. Applying persistence criteria would likely not result in online training for this image. However, it is likely, for example, that many such single face images that are important will be posed for or otherwise taken up close, i.e., they will be “prominent” in the image. Thus, online training may occur if the size of the unknown face in an image is larger than a predefined threshold or at least as large as the ones that are in the MPNN 42. Application of one or more of such prominence criteria will also serve to exclude those faces in the image that are smaller and more likely to be background images.

It is noted that for discrete images one or more prominence criteria may be applied either alone or in combination with one or more persistence criteria. It is also noted that prominence criteria may also be applied to video input, either as an alternative to persistence criteria or together with persistence criteria.

While the invention has been described with reference to several embodiments, it will be understood by those skilled in the art that the invention is not limited to the specific forms shown and described. Thus, various changes in form and details may be made therein without departing from the spirit and scope of the invention as defined by the appended claims. For example, there are many alternative techniques that may be used in the present invention for face detection 30. An exemplary alternative technique of face detection as known in the art is further described in “Neural Network-Based Face Detection” by H. A. Rowley et al., IEEE Transactions On Pattern Analysis and Machine Intelligence”, vol. 20, no. 1, pp. 23-38 (January, 1998).

In addition, other techniques of feature extraction may be used as alternatives to VQ histogram techniques described above. For example, the well-known “eigenface” technique may be used for comparing facial features. In addition, there are many variations of PNN classification that may be used as an alternative to the MPNN described above for face classification in which, for example, the online training techniques described above may be utilized. Also, there are many other techniques of face classification which may be used as alternatives to (or in techniques apart from) the MPNN technique utilized in the above exemplary embodiment, such as RBF, Naive Bayesian Classifier, and nearest neighbor classifier. The online training techniques, including the appropriate persistence and/or prominence criteria, may be readily adjusted to such alternative techniques.

Also, it is noted, for example, that the embodiment described above does not necessarily have to be initially offline trained with images of N different sample faces. The initial MPNN 42 may not have any offline trained nodes, and may be trained exclusively online with faces that meet the one or more persistence (or prominence) criteria, in the manner described above.

Also, persistence criteria other than those specifically discussed above fall within the scope of the invention. For example, the threshold time that a face needs to be present in a video input may be a function of video content, scene in the video, etc. Thus, the particular techniques described above are by way of example only and not to limit the scope of the invention.

1) A system (10) having a face classifier (40) that provides a determination that a face image in a video input (20) is an unknown face if it fails to correspond to any one known face stored in the classifier (40), the system (10) adding the unknown face to the classifier (40) when the unknown face persists in the video input (20) in accordance with one or more persistence criteria (100).

2) The system (10) as in claim 1, wherein the face classifier (40) comprises a probabilistic neural network (PNN) (42).

3) The system (10) as in claim 2, wherein the face image in the video input (20) comprises a known face if it corresponds to a category in the PNN (42).

4) The system (10) as in claim 3, wherein the system (10) adds the unknown face to the PNN (42) by addition of a category and one or more pattern nodes for the unknown face to the PNN (42), thereby rendering the unknown face to be known to the system (10).

5) The system (10) as in claim 2, wherein the one or more persistence criteria (100) comprises determining the same unknown face is present in the video input for a minimum period of time.

6) The system (10) as in claim 5, wherein the unknown face is tracked in the video input (20).

7) The system (10) as in claim 5, wherein the one or more persistence criteria (100) comprise:
a) a sequence of unknown faces in the video input (20) is determined by the PNN (42);
b) a mean probability distribution function (PDF) value of feature vectors for the sequence of faces is below a first threshold;
c) the variance of feature vectors for the sequence of faces is below a second threshold; and
d) criteria a, b and c are satisfied for a minimum period of time.

8) The system (10) as in claim 7, wherein the minimum period of time is greater than or equal to approximately 10 seconds.

9) The system (10) as in claim 2, wherein the PNN (42) applies a threshold to a PDF value of a feature vector for the face image with respect to a category in determining whether it is an unknown face, the threshold being determined based upon the PDF of the category.

10) The system (10) as in claim 9, wherein the threshold is a percentage of the maximum value of the PDF for the category.

11) The system (10) as in claim 1, wherein a number of known faces stored in the classifier (40) comprise face categories stored during an offline training.

12) The system (10) as in claim 1, wherein all known faces stored in the classifier (40) are unknown faces that persist in the video input and are added by the system (10) to the classifier (40).

13) A method of face recognition comprising the steps of:
a) determining whether a face image in a video input (20) corresponds to a known face in a set of known faces and, if not, determining that the face image is unknown,
b) determining whether the unknown face persists in the video input (20) in accordance with one or more persistence criteria (100), and
c) processing the unknown face to become a known face in the set when the one or more persistence criteria (100) of step b is met.

14) The method as in claim 13, wherein the one or more persistence criteria (100) comprises determining the same unknown face is present in the video input (20) for a minimum period of time.

15) The method as in claim 14, wherein the one or more persistence criteria (100) comprises tracking the unknown face in the video input (20) for a minimum period of time.

16) The method as in claim 14, wherein the one or more persistence criteria comprises determining that the following are satisfied for a minimum period of time:
i) there is a sequence of unknown faces in the video input (20);
ii) a mean probability distribution function (PDF) value of feature vectors of the sequence of unknown faces is below a first threshold; and
iii) the variance of feature vectors for the sequence of faces is below a second threshold.

17) The method as in claim 13, wherein determining that the face is unknown includes determining that a PDF value of the feature vector for the face image with respect to a face category is below a threshold, wherein the threshold is based upon the PDF of the category.

18) The method as in claim 13, wherein the set of known faces initially includes no known faces.

19) A system (10) having a face classifier (40) that provides a determination that a face image in input images is an unknown face if it fails to correspond to any one known face stored in the classifier (40), the system (10) adding the unknown face to the classifier (40) when the unknown face in the input images meets at least one of: one or more persistence criterion (100) and one or more prominence criteria.

20) The system (10) as in claim 19, wherein the input images are provided by an image archive.

21) The system (10) as in claim 19, wherein the input images provided are images taken of one or more locations.

22) The system (10) as in claim 19, wherein the one or more persistence criteria (100) comprises determining the same unknown face is present in a minimum number of the input images.

23) The system (10) as in claim 19, wherein the one or more prominence criteria comprises determining an unknown face has at least a threshold size in at least one image.

24) The system (10) as in claim 19, wherein the input images are at least one of video images and discrete images.
